(19) United States
(12) Patent Application Publication
(10) Pub. No.: US 2004/0085432 A1
(43) Pub. Date: May 6, 2004

(54) Multi-color development thermal printer, multi-color development method and multi-color development system

(75) Inventors: Ichiro Uratani, Saitama (JP); Katsuyoshi Suzuki, Tokyo (JP); Minoru Suzuki, Tochigi (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/637,489

(22) Filed: Aug. 11, 2003

(30) Foreign Application Priority Data
Aug. 12, 2002 (JP) P2002 - 234591

(51) Int. Cl. B41J 2/325

(52) U.S. Cl. 347/172

(57) ABSTRACT

A multi-color development thermal printer develops simultaneously magenta, cyan, and black using a line-type thermal head on a recording medium, which develops magenta at a low temperature, cyan at an intermediate temperature, and black at a high temperature. One line's worth of first two-color development bit data for developing magenta and black, and one line's worth of second two-color development bit data for developing cyan and black, are generated based on one line's worth of three-color development bit data. During a period required for a recording operation of one line by the line-type thermal head, the line-type thermal head performs a first recording operation in accordance with one line's worth of the first two-color development bit data, and then a second recording operation in accordance with one line's worth of the second two-color development bit data.

### BACKGROUND OF THE INVENTION

1. Field of the Invention

The present invention relates to a multi-color development thermal printer, a multi-color development method, and a multi-color development system, which simultaneously develop first, second, and third colors using a line-type thermal head, in accordance with one line's worth of three-color development pixel data, on a recording medium, which has color-characteristics developing a first color at a first temperature, a second color at a second temperature higher than the first temperature, and a third color at a third temperature higher than the second temperature.

2. Description of the Related Art

As is well known, a thermal printer is utilized for recording a character or image on a thermo-sensitive recording medium. As a thermo-sensitive recording medium, a multi-color development thermo-sensitive recording medium is known. This medium is constructed in such a manner that a chromatic color, such as magenta and cyan, is developed in addition to black. Namely, a color development layer of the multi-color development thermo-sensitive recording medium contains thermo-sensitive coloring material having different coloring temperatures, so that a magenta thermo-sensitive coloring material has a low-temperature coloring characteristic, a cyan thermo-sensitive coloring matter has an intermediate-temperature coloring characteristic, and a black thermo-sensitive coloring material has a high-temperature coloring characteristic, for example. According to the multi-color development thermo-sensitive recording medium having the above coloring characteristics, magenta is developed by a coloring at a low temperature, a mixture of magenta and cyan, i.e. blue, is developed by a coloring at an intermediate temperature, and black is developed by coloring at a high temperature.

When multi-color development recording is carried out on a multi-color development thermo-sensitive recording medium, using a line-type thermal printer, three line-type thermal heads are needed. Namely, a first line-type thermal head is used for coloring magenta, a second line-type thermal head is used for coloring cyan, and a third line-type thermal head is used for coloring black. On the same line on the multi-color development thermo-sensitive recording medium, the first, second, and third line-type thermal heads are sequentially actuated based on one line's worth of magenta development bit data, one line's worth of cyan development bit data, and one line's worth of black development bit data, so that the three-color development dots, i.e., a magenta development dot, a blue development dot, and a black development dot, are generated on the line.

The multi-color development thermal printer should be provided with three line-type thermal heads, resulting in increased production and component costs for the printer. Thus, a multi-color development method has been proposed, in which a single-line-type thermal printer is used to simultaneously carry out magenta development, cyan development, and black development for every one line.

In this conventional multi-color development method, first, one line's worth of first, second, and third color development bit data is generated based on one line's worth of three-color development pixel data. In one line's worth of the first color development bit data, “1” is set to all of bit data for developing magenta, cyan, and black. In one line's worth of the second color development bit data, “1” is set to only bit data for developing cyan and black. In one line's worth of the third color development bit data, “1” is set to only bit data for developing black.

During a period required for recording one line by a single-line-type thermal head, the thermal head performs a recording operation based on one line's worth of first color development bit data, performs a recording operation based on one line's worth of second color development bit data, and performs a recording operation based on one line's worth of third color development bit data, so that magenta development, blue development, and black development are simultaneously performed for each line on the multi-color development recording medium. Namely, the recording time of the single-line-type thermal head based on one line's worth of first color development bit data is a time required for performing the magenta development, the recording time of the single-line-type thermal head based on one line's worth of first and second color development bit data is a time required for performing the cyan development, and the recording time of the single-line-type thermal head based on one line's worth of first, second, and third color development bit data is a time required for performing the black development.

Note that, in such a multi-color development method, while a black development dot is obtained as a single full-size dot, a magenta development dot and a blue (i.e., magenta+cyan) development dot are partly developed dots and hence smaller than the full-size dot and the color density is deceased. However, such a problem can be overcome by increasing the densities of the magenta development thermo-sensitive coloring material and cyan development thermo-sensitive coloring material.

As understood from the above description, in a conventional multi-color development method, it is necessary that one line's worth of first, second, and third color development bit data are generated based on one line's worth of three color development pixel data. If the bit data are generated by a host computer to which the multi-color development thermal printer is connected, the transmittance of the color development bit data takes three times as long as a normal case (or mono-color development), resulting in the problem of the recording operation time of the thermal printer being too long.

On the other hand, it is possible for the printer controller to receive one line's worth of three-color development pixel data output from the host computer to generate one line's worth of first, second, and third color development bit data. However, generally speaking, since the performance of the printer controller is inferior to that of the host computer, it takes time to generate one line's worth of first, second, and third color development bit data. Thus, in this case, the problem is that the recording operation time in the thermal printer becomes long.

Further, in a recording operation for each line on a multi-color development recording medium, the amount of color development bit data is three times that of a normal case, and therefore, the capacities of the buffers, which temporarily hold color development bit data during a recording operation, should be increased. Due to this, the cost of the multi-color development thermal printer becomes high.

### SUMMARY OF THE INVENTION

Therefore, an object of the present invention is to provide a multi-color development thermal printer, a multi-color development method, and a multi-color development system, for which not only is the recording operation time shortened, but also the cost is reduced. The multi-color development thermal printer, the multi-color development method, and the multi-color development system simultaneously develop on a recording medium, first, second, and third colors using a line-type thermal head, in accordance with one line's worth of three-color development pixel data. The recording medium has color-characteristics, developing a first color at a first temperature, a second color at a second temperature higher than the first temperature, and a third color at a third temperature higher than the second temperature.

According to the present invention, there is provided a multi-color development thermal printer comprising a storing processor and a recording processor.

The storing processor stores one line's worth of first two-color development bit data generated based on one line's worth of the three-color development pixel data so as to develop the first and third colors, and one line's worth of second two-color development bit data generated based on one line's worth of the three-color development pixel data so as to develop the second and third colors. The recording processor controls the line-type thermal head to perform a first recording operation based on one line's worth of the first two-color development bit data, and then controls the line-type thermal head to perform a second recording operation based on one line's worth of the second two-color development bit data, during a period required for carrying out a recording operation for every one line of the line-type thermal head.

The recording processor may control the line-type thermal head to perform a third recording operation based on one line's worth of the first two-color development bit data, after performing the second recording operation based on one line's worth of the second two-color development bit data.

The recording processor may control the line-type thermal head to perform the second recording operation, and then may control the line-type thermal head to perform the first recording operation, during a period required for carrying out a recording operation for every one line of the line-type thermal head.

Further, according to the present invention, there is provided a multi-color development method comprising a first bit data generating step, a second bit data generating step, and a recording step.

The first bit data generating step is performed for generating one line's worth of first two-color development bit data based on one line's worth of the three-color development pixel data so as to develop the first and third colors. The second bit data generating step is performed for generating one line's worth of second two-color development bit data based on one line's worth of the three-color development pixel data so as to develop the second and third colors. The recording step is performed for controlling the line-type thermal head to perform a first recording operation based on one line's worth of the first two-color development bit data, and then controls the line-type thermal head to perform a second recording operation based on one line's worth of the second two-color development bit data, during a period required for carrying out a recording operation for every one line of the line-type thermal head.

Preferably, a first recording time of the line-type thermal head for performing the first recording operation is a time required for obtaining a first coloring temperature at which the first color occurs, and a second recording time of the line-type thermal head for performing the second recording operation is a time required for obtaining a second coloring temperature at which the second color occurs.

In the recording step, the line-type thermal head may be controlled to perform a third recording operation based on one line's worth of the first two-color development bit data, after performing the second recording operation based on one line's worth of the second two-color development bit data. In this case, a first recording time of the line-type thermal head to perform the first recording operation may be a time required for obtaining a first coloring temperature at which the first color occurs, a second recording time of the line-type thermal head to perform the second recording operation may be a time required for obtaining a second coloring temperature at which the second color occurs, and a third recording time of the line-type thermal head to perform the third recording operation may be a time required for obtaining a third coloring temperature at which the first color occurs.

Furthermore, according to the present invention, there is provided a multi-color development system comprising a first bit data generator, a second bit data generator, a storing processor, and a recording processor.

The first bit data generator generates one line's worth of first two-color development bit data based on one line's worth of the three-color development pixel data so as to develop the first and third colors. The second bit data generator generates one line's worth of second two-color development bit data based on one line's worth of the three-color development pixel data so as to develop the second and third colors. The storing processor stores one line's worth of each of the first and second two-color development pixel data. The recording processor controls the line-type thermal head to perform a first recording operation based on one line's worth of the first two-color development bit data, and then controls the line-type thermal head to perform a second recording operation based on one line's worth of the second two-color development bit data, during a period required for carrying out a recording operation for every one line of the line-type thermal head.

The recording processor may control the line-type thermal head to perform a third recording operation based on one line's worth of the first two-color development bit data, after performing the second recording operation based on one line's worth of the second two-color development bit data.

The recording processor may control the line-type thermal head to perform the second recording operation, and then may control the line-type thermal head to perform the first recording operation, during a period required for carrying out a recording operation for every one line of the line-type thermal head.

### BRIEF DESCRIPTION OF THE DRAWINGS

The objects and advantages of the present invention will be better understood from the following description, with reference to the accompanying drawings in which:

FIG. 1 is a block diagram of a multi-color development thermal printer to which an embodiment of the present invention is applied;

FIG. 2 is a flowchart of a three-color pixel data process routine performed by a host computer connected to the thermal printer shown in FIG. 1;

FIG. 3 is a schematic view showing examples of a part of one line's worth of three-color pixel data, a part of one line's worth of each of first and second two-color development bit data generated based on the three-color pixel data;

FIG. 4 is a timing chart showing a multi-color development recording operation carried out by the multi-color development thermal printer shown in FIG. 1;

FIG. 5 is a schematic view showing magenta, blue, black, and colorless dots formed on a color development layer of a multi-color development thermo-sensitive recording medium by the multi-color development recording operation shown in the timing chart of FIG. 4;

FIG. 6 is a schematic view similar to FIG. 3, for explaining a comparison example of multi-color development method;

FIG. 7 is a schematic view similar to FIG. 5, for explaining a comparison example of multi-color development method;

FIG. 8 is a timing chart similar to FIG. 4, for carrying out the other embodiment of the multi-color development method of the present invention; and

FIG. 9 is a schematic view showing magenta, blue, black, and colorless dots formed on a color development layer of a multi-color development thermo-sensitive recording medium by the multi-color development recording operation shown in the timing chart of FIG. 8.

### DESCRIPTION OF THE PREFERRED EMBODIMENTS

The present invention will be described below with reference to the embodiments shown in the drawings.

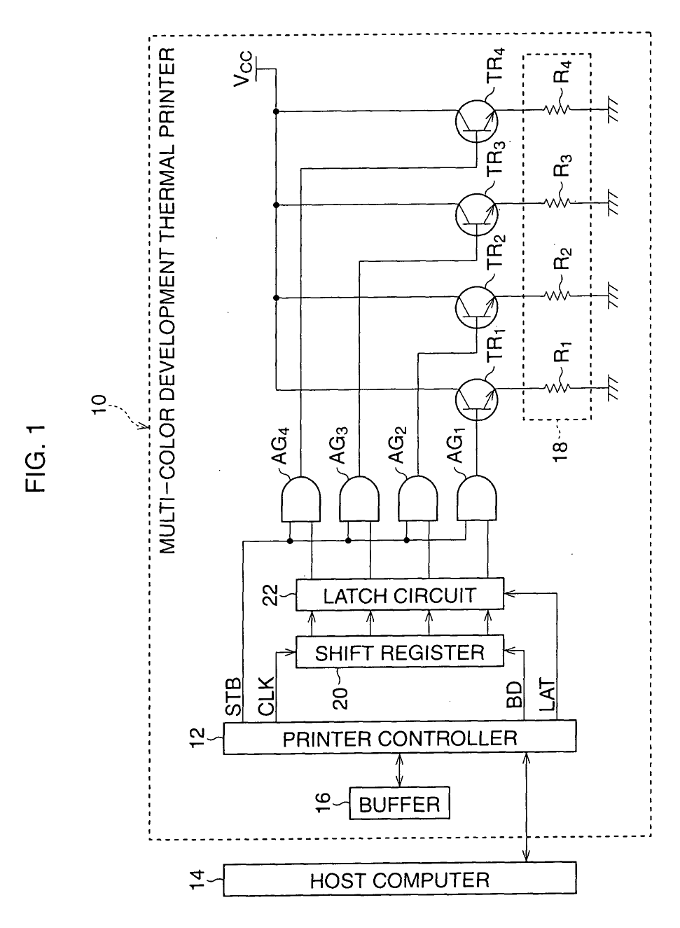

FIG. 1 shows a block diagram of a multi-color development thermal printer 10 to which an embodiment of the present invention is applied. In the multi-color development thermal printer 10, a printer controller 12 is installed. The printer controller 12 has a micro-computer, which controls a CPU, a ROM storing constants and a program for performing various kinds of routines, a RAM temporarily storing data and so on, and an I/O interface, to control the multi-color development thermal printer as a whole.

The printer controller 12 is connected to the host computer 14 through the I/O interface, so that a communication is carried out between the printer controller 12 and the host computer 14. The host computer 14 also has a micro-computer, which controls a CPU, a ROM for storing constants and a program for performing various kinds of routines, a RAM for temporarily storing data and so on, and an I/O interface. The host computer 14 is further provided with a memory driver controlling a proper memory such as a hard disk, a floppy disk, and a CD. Note that the host computer 14 is connected to a monitor such as a CRT, and an external input device such as a keyboard and a mouse, these are not shown in FIG. 1.

In the host computer 14, document data, image data and so on are generated, which are stored in a memory such as a hard disk, in a predetermined format. In the embodiment, pixel data of the document data and the image data are formed as 2-bit data. Namely, when the pixel data is [00], it defines colorless. When the pixel data is [01], it defines magenta, when the pixel data is [10], it defines cyan, and when the pixel data is [11], it defines black.

When the host computer 14 performs a multi-color development recording operation based on document data, image data and so on, using the multi-color development thermal printer 10, three-color development pixel data are processed for every one line, as described later, so that one line's worth of first two-color development bit data and one line's worth of second two-color development bit data are generated. The one line's worth of each of the first and second two-color development bit data is transmitted in order from the host computer 14 to the printer controller 12. In the printer controller 12, one line's worth of each of the first and second two-color development bit data is temporarily stored in the buffer 16, and read out from the buffer 16 in a recording operation.

The multi-color development thermal printer 10 is provided with a line-type thermal head 18, which has lots of heating elements or electric resistance elements provided on a substrate and aligned on a line with a predetermined pitch. Although four electric resistance elements R1, R2, R3, and R4 are representatively indicated as the electric resistance elements in FIG. 1, in reality, the number of the electric resistance elements provided in the line-type thermal head 18 is 2400, for example.

One terminal of each of the electric resistance elements R1, R2, R3, and R4 is grounded, and the other terminals of the electric resistance elements R1, R2, R3, and R4 are connected to emitters of the corresponding transistors TR1, TR2, TR3, and TR4. A voltage V_{cc} of a power source is applied to a collector of each of the transistors TR1, TR2, TR3, and TR4. The base of each of the transistors TR1, TR2, TR3, and TR4 is connected to an output terminal of each of AND gates AG1, AG2, AG3, and AG4.

The multi-color development thermal printer 10 is provided with a shift register 20 and a latch circuit 22. In a recording operation, one line's worth of two-color development bit data BD is read from the buffer 16 through the printer controller 12, and is sequentially transmitted to the shift register 20 in accordance with a clock pulse CLK output from the printer controller 12 to the shift register 20, and is then temporarily stored in the shift register 20.

When the whole of one line's worth of two-color development bit data BD is transmitted to the shift register 20, a latch signal LAT is output from the printer controller 12 to the latch circuit 22, so that one line's worth of two-color development bit data BD is transferred from the shift register 20 to the latch circuit 22, and held there until a next latch signal LAT is output. On the other hand, when the one line's worth of two-color development bit data BD is transmitted from the shift register 20 to the latch circuit 22, the next one line's worth of two-color development bit data BD is transmitted from the printer controller 12.

Output terminals corresponding to the bit data are provided to the latch circuit 22. Each of the output terminals is connected to first input terminals of each of the AND gates AG1, AG2, AG3, and AG4, and a strobe signal STB output from the printer controller 12 is input to a second input terminal of the AND gates. Thus, only when a value “1” is given to bit data corresponding to the AND gates AG1, AG2, AG3, and AG4, is a high-level signal input to the second input terminal of the AND gates, and therefore, only when the strobe signal STB is high-level, is a high-level signal output from the output terminal of the AND gate to the base of the transistor TR1, TR2, TR3, or TR4, so that electric current is supplied to the electric resistance element R1, R2, R3, or R4, to heat.

In the embodiment, for the multi-color development thermal printer 10, a multi-color development thermo-sensitive recording medium, which can develop magenta, cyan, and black, is used. The recording medium has color characteristics, developing magenta at the lowest temperature T1, cyan at a temperature T2 higher than the temperature T1, and black at a temperature T3 higher than the temperature T2. The multi-color development thermal printer 10 is provided with a platen roller pressed by a predetermined pressure, and a drive mechanism for rotating the platen roller, which are not shown in FIG. 1. In a recording operation, the platen roller is rotated by the drive mechanism, so that the multi-color development thermo-sensitive recording medium is passed between the thermal head 18 and the platen roller at a constant speed.

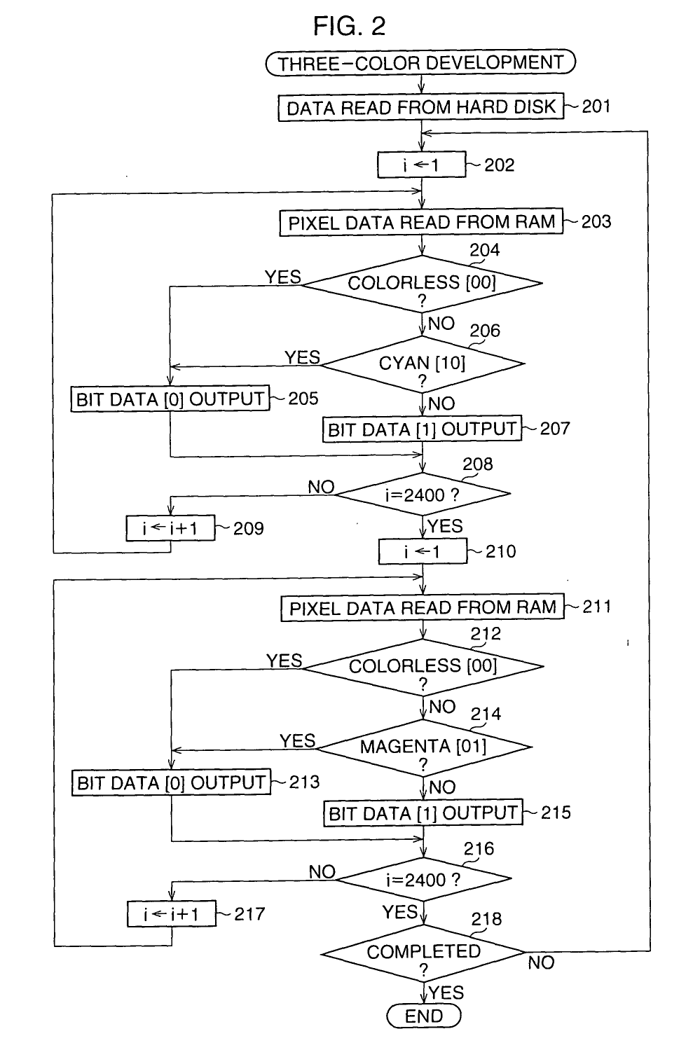

FIG. 2 shows a flowchart of a three-color pixel data process routine performed by the host computer 14. The three-color pixel data process routine is performed when a record command is input through an external input device such as a keyboard or a mouse connected to the host computer 14, by an operator.

In Step 201, document data or image data to be recorded or printed are read out from a hard disk one line by one line at a proper time interval, and stored in the RAM of the host computer 14. Then, in Step 202, a counter “i” is initialized to “1”. In Step 203, a first pixel data contained in the three-color pixel data of the first one line is read from the RAM of the host computer 14, and in Step 204, it is determined whether the read pixel data indicates colorless [00].

If the read pixel data is colorless [00], the process goes to Step 205, in which a bit data [0] is output from the host computer 14 to the printer controller 12. In the printer controller 12, the bit data [0] is written in the buffer 16. Conversely, when it is determined in Step 204 that the read pixel data is not colorless [00], the process goes to Step 206, in which it is determined whether the read pixel data is cyan [10]. If the read pixel data is cyan [10], the process goes to Step 205, in which a bit data [0] is output from the host computer 14 to the printer controller 12, in which the bit data [0] is written in the buffer 16.

When the read pixel data is not cyan [10] in Step 206, i.e., when the read pixel data is magenta [01] or black [11], the process goes to Step 207, in which a bit data [1] is output from the host computer 14 to the printer controller 12, where the bit data [1] is written in the buffer 16.

Thus, when the read pixel data is colorless [00] or cyan [10], the bit data [0] is written in the buffer 16, and when the read pixel data is magenta [01] or black [11], the bit data [1] is written in the buffer 16.

After the bit data [0] or [1] is output with respect to the read pixel data (Step 205 or 207), the process goes to Step 208, in which it is determined whether the counter “i” has reached 2400. When the counter “i” is less than 2400, the process goes to Step 209, so that the counter “i” is increased by 1, and the process goes back to Step 203.

As described above, since the thermal head 18 is provided with 2400 electric resistance elements, one line of document data and image data to be recorded or printed contains 2400 pixel data. By repeating a loop composed of Steps 203 through 209, for 2400 pixel data contained in one line, bit data are output in a way as described above.

When it is determined in Step 208 that the counter “i” has reached 2400, Step 210 is executed in which the counter “i” is initialized to 1. Then, in Step 211, the first pixel data contained in three-color pixel data of the first one line is again read from the RAM of the host computer 14, and in Step 212, it is determined whether the read pixel data indicates colorless [00].

If the read pixel data is colorless [00], the process goes to Step 213, in which a bit data [0] is output from the host computer 14 to the printer controller 12. In the printer controller 12, the bit data [0] is written in the buffer 16. Conversely, when it is determined in Step 212 that the read pixel data is not colorless [00], the process goes to Step 214, in which it is determined whether the read pixel data is magenta [01]. If the read pixel data is magenta [01], the process goes to Step 213, in which a bit data [0] is output from the host computer 14 to the printer controller 12, in which the bit data [0] is written in the buffer 16.

When the read pixel data is not magenta [01] in Step 214, i.e., when the read pixel data is cyan [10] or black [11], the process goes to Step 215, in which a bit data [1] is output from the host computer 14 to the printer controller 12, where the bit data [1] is written in the buffer 16.

Thus, when the read pixel data is colorless [00] or magenta [01], the bit data [0] is written in the buffer 16, and when the read pixel data is cyan [10] or black [11], the bit data [1] is written in the buffer 16.

After the bit data [0] or [1] is output with respect to the read pixel data (Step 213 or 215), the process goes to Step 216, in which it is determined whether the counter “i” has reached 2400. When the counter “i” is less than 2400, the process goes to Step 217, so that the counter “i” is increased by 1, and the process goes back to Step 211.

When it is determined in Step 216 that the counter “i” has reached 2400, i.e., that the output of bit data has been completed with respect to 2400 pixel data contained in one line, the process goes to Step 218, in which it is determined whether the output of bit data has been completed with respect to the pixel data contained in all of the lines of the document data or the image data which are to be recorded or printed. If the output has not been completed, the process goes back to Step 202, so that the output of bit data is carried out again with respect to the pixel data contained in each of the lines.

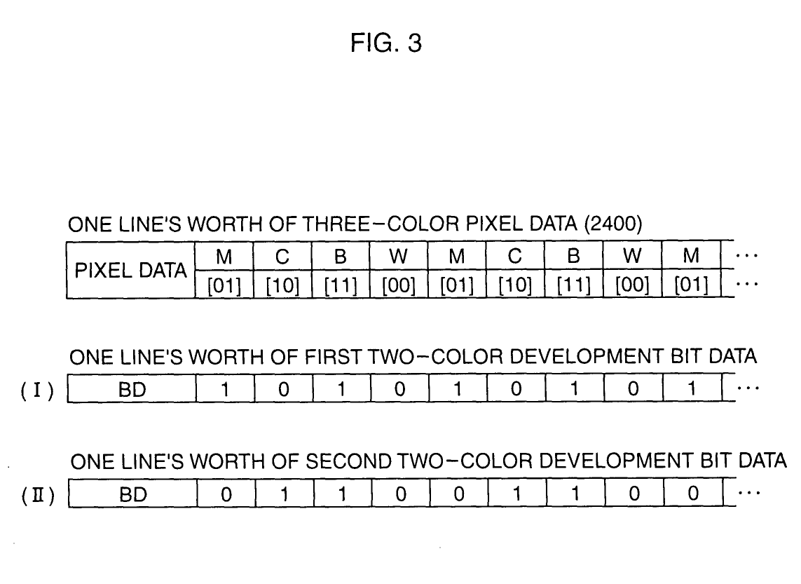

FIG. 3 shows an example of a part of one line's worth of three-color pixel data. Note that, in FIG. 3, “M” indicates magenta pixel data, “C” indicates cyan pixel data, “B” indicates black pixel data, and “W” indicates colorless pixel data. FIG. 3 also shows a part of one line's worth of each of the first and second two-color development bit data BD, obtained based on one line's worth of three-color pixel data. One line's worth of the first two-color development bit data shown by reference (I) is obtained by the execution of Steps 203 through 209 of the three-color pixel data process routine. One line's worth of the second two-color development bit data shown by reference (II) is obtained by the execution of Steps 211 through 217 of the three-color pixel data process routine. Thus, in the host computer 14, by executing the three-color pixel data process routine, one line's worth of first and one line's worth of second two-color development bit data BD are generated in order based on the common three-color pixel data line, and then written in the buffer 16.

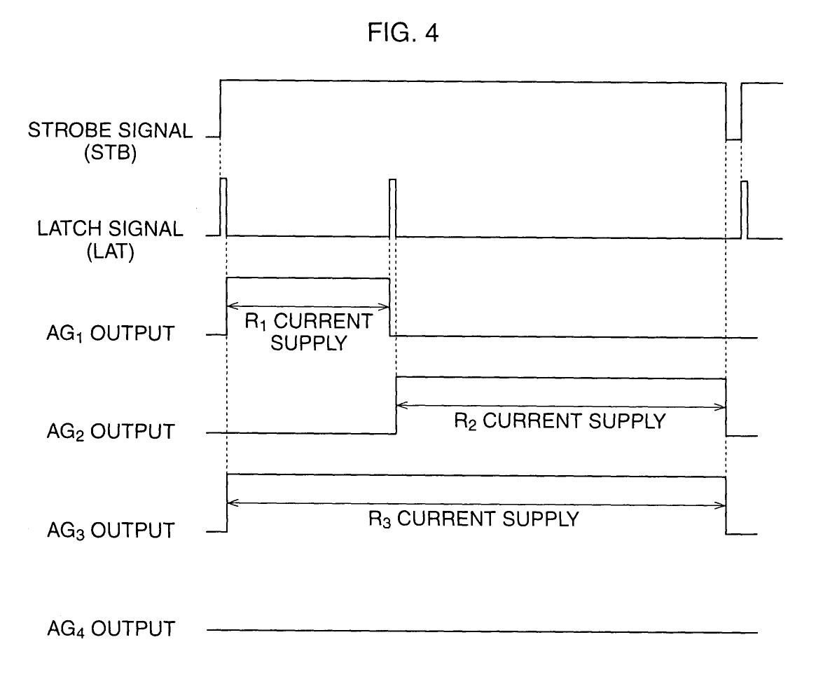

In the multi-color development thermal printer 10, the recording (or printing) operation is performed according to the timing chart shown in FIG. 4. For a recording operation of one line, first, one line's worth of the first two-color development bit data BD is read from the buffer 16, and output to the shift register 20. The writing operation of the bit data BD to the shift register 20 is carried out in accordance with a clock pulse CLK output from the printer controller 12 to the shift register 20.

When all of one line's worth of the first two-color development bit data BD (2400 bit data) is input to the shift register 20, a latch signal (LAT) is output from the printer controller 12 to the latch circuit 22, so that 2400 bit data are simultaneously shifted from the shift register 20 to the latch circuit 22, and held there. When one line's worth of the first two-color development bit data BD (2400 bit data) is as shown in FIG. 3, and the first through fourth bit data [1], [0], [1], and [0] correspond to the AND gates AG1, AG2, AG3, and AG4, a high-level signal is output from the latch circuit 22 to the first input terminals of each of the AND gates AG1, and AG3, and a low-level signal is output from the latch circuit 22 to the first input terminals of each of the AND gates AG2, and AG4.

Note that, when a latch signal LAT is output, one line's worth of the second two-color development bit data BD is read from the buffer 16, and the one line's worth of the second two-color development bit data BD is written in the shift register 20 in accordance with the clock pulse CLK output from the printer controller 12 to the shift register 20.

As understood from the timing chart of FIG. 4, at the same time when a latch signal LAT is output from the printer controller 12 to the latch circuit 22, a strobe signal STB is output from the printer controller 12 to the second input terminal of each of the AND gates AG1, AG2, AG3, and AG4. Therefore, in accordance with the first through fourth bit data [1], [0], [1], and [0], high-level signals are output from the output terminals of the AND gates AG1 and AG3, and low-level signals are output from the output terminals of the AND gates AG2 and AG4. Thus, as shown in FIG. 4, only the electric resistors R1 and R3 are supplied with electric current to be heated. Namely, when the strobe signal STB rises, the electric resisters R1 and R3, which correspond to black, developed at the highest temperature, and another color (magenta), are heated.

After a predetermined time has passed, i.e., after a heating period for magenta, which is the color other than black developed at the highest temperature, has passed, when the latch signal LAT is again output from the printer controller 12 to the latch circuit 22, one line's worth of the second two-color development bit data BD (2400 bit data) is simultaneously shifted from the shift register 20 to the latch circuit 22, and held in the latch circuit 22. Note that, when the latch signal LAT is output, one line's worth of the next first two-color development bit data BD is read from the buffer 16, and the one line's worth of the first two-color development bit data BD is written in the shift register 20 in accordance with the clock pulse CLK output from the printer controller 12 to the shift register 20.

As shown in FIG. 3, since the first through fourth bit data contained in one line's worth of the second two-color development bit data are [0], [1], [1], and [0], high-level signals are output from the latch circuit 22 to the first input terminals of the AND gates AG2 and AG3, and low-level signals are output from the latch circuit 22 to the second input terminals of the AND gates AG1 and AG4. Therefore, in accordance with the first through fourth bit data [0], [1], [1], and [0], high-level signals are output from the output terminals of the AND gates AG2 and AG3, and low-level signals are output from the output terminals of the AND gates AG1 and AG4. Thus, as shown in FIG. 4, only the electric resistors R2 and R3 are supplied with electric current, to be heated.

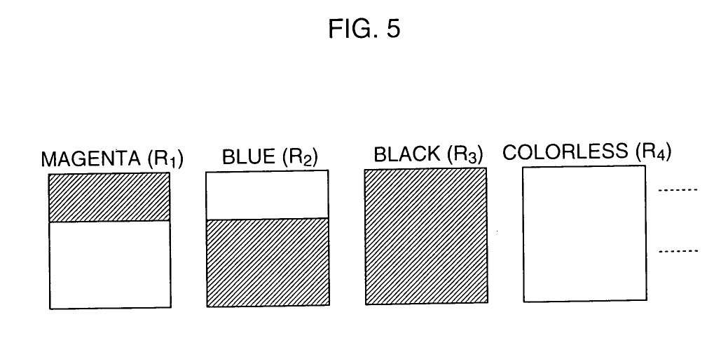

As a result, a magenta dot, a blue (i.e., magenta+cyan) dot, a black dot, and a colorless dot are formed on a color development layer of the multi-color development thermo-sensitive recording medium by the electric resistance elements R1, R2, R3, and R4, as schematically shown in FIG. 5. The current supply period for the electric resistance element R1 is set in such a manner that the heat temperature becomes higher than or equal to the magenta development temperature T1 and lower than the cyan development temperature T2. The current supply period for the electric resistance element R2 is set in such a manner that the heat temperature becomes higher than or equal to the cyan development temperature T2 and lower than the black development temperature T3. The current supply period for the electric resistance element R3 is set in such a manner that the heat temperature becomes higher than the black development temperature T3. Note that, as understood from FIG. 4, the current supply period for the electric resistance element R3 is equal to the sum of the current supply period for the electric resistance element R1 and the current supply period for the electric resistance element R2.

Note that, although the current supply period for the electric current element R2 is interrupted for a short time every time the latch signal LAT is output, it is deemed to be continuous as a whole.

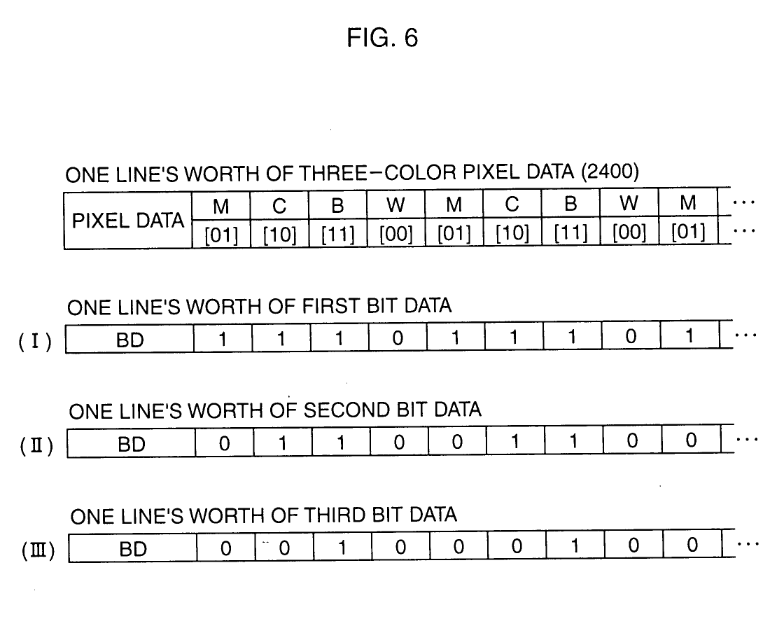

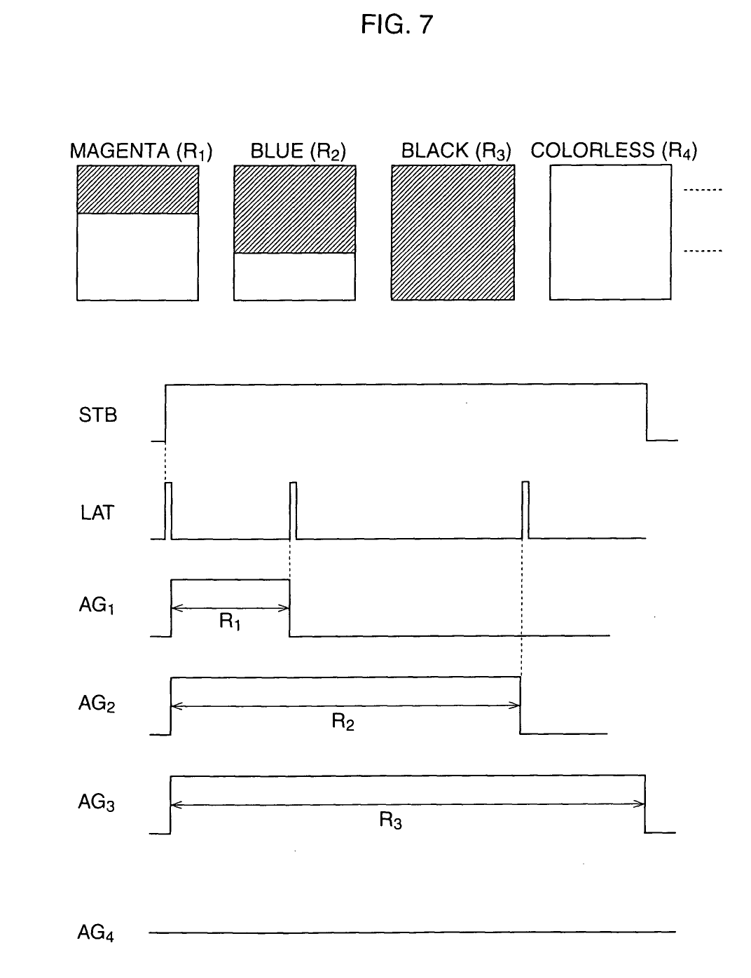

FIGS. 6 and 7 show a comparison example of a multi-color development method. A part of one line's worth of the three-color pixel data shown in FIG. 6 is identical with that shown in FIG. 3. In the comparison example, one line's worth of each of the first, second, and third bit data BD are generated based on one line's worth of three-color pixel data. Namely, in one line's worth of the first bit data BD shown by (I), bit data [1] is given for each of the magenta pixel data, the cyan pixel data, and the black pixel data. In one line's worth of the second bit data BD shown by (II), bit data [1] is given for the cyan pixel data, and the black pixel data, and in one line's worth of the third bit data BD shown by (III), bit data [1] is given for only the black pixel data.

In the comparison example of the multi-color development method, during the output of the strobe signal STB, one line's worth of the first, second, and third bit data BD are input in order, with a proper time interval, to the latch circuit 22, so that a magenta dot, a blue (i.e., magenta+cyan) dot, a black dot, and a colorless dot are formed on a color development layer of the multi-color development thermo-sensitive recording medium, as schematically shown in FIG. 7.

In the comparison example of the multi-color development method, it is necessary to generate one line's worth of each of the first, second, and third bit data to develop multi-color for every one line. Conversely, in the embodiment, it is necessary to generate one line's worth of each of the first and second two-color development bit data to develop multi-color for each line. In other words, in the embodiment, the thermal head 18 (i.e., electric resistance elements) is controlled to perform a first recording operation based on one line's worth of the first two-color development bit data, and then perform a second recording operation based on one line's worth of the second two-color development bit data, during a period required for carrying out a recording operation for every one line of the thermal head 18.

In the comparison example of the multi-color development method, it is necessary to generate one line's worth of each of the first, second, and third bit data to develop multi-color for every one line. Conversely, in the embodiment, it is necessary to generate one line's worth of each of the first and second two-color development bit data to develop multi-color for each line. In other words, in the embodiment, the thermal head 18 (i.e., electric resistance elements) is controlled to perform a first recording operation based on one line's worth of the first two-color development bit data, and then perform a second recording operation based on one line's worth of the second two-color development bit data, during a period required for carrying out a recording operation for every one line of the thermal head 18.

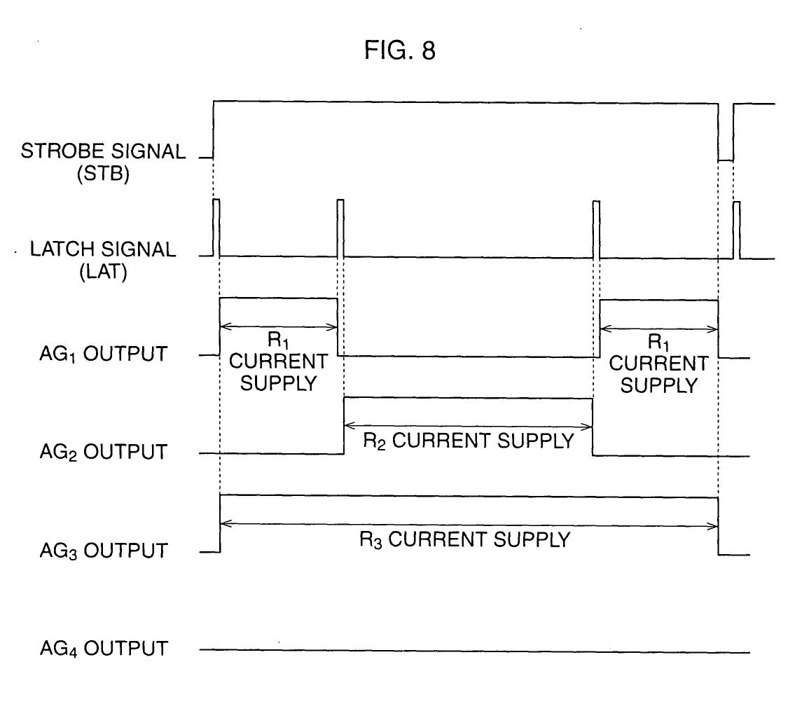

FIG. 8 shows a timing chart for carrying out the multi-color development of the other embodiment of the present invention.

In the multi-color development recording operation, during the output of the strobe signal STB, the latch signal LAT is output from the printer controller 12 to the latch circuit 22 three times. In a similar way as the multi-color development shown in FIG. 4, before the first latch signal LAT is output, one line's worth of the first two-color development bit data BD ((I) of FIG. 3) is written in the shift register 20. Therefore, when the first latch signal LAT is output, one line's worth of two-color development bit data BD is shifted from the shift register 20 to the latch circuit 22, so that high-level signals are output from the output terminals of the AND gates AG1 and AG3, and thus, only the electric resistance elements R1 and R3 are supplied with electric current, to be heated. Note that, in a similar way as the multi-color development recording operation shown in FIG. 4, after the first latch signal LAT is output, one line's worth of the second two-color development bit data BD ((II) of FIG. 3) is written in the shift register 20.

After a sufficient time has passed, i.e., after the heating period for magenta has passed, the second latch signal LAT is output from the printer controller 12 to the latch circuit 22, and at this time, one line's worth of the second two-color development bit data BD is shifted from the shift register 20 to the latch circuit 22. Therefore, in a similar way as the multi-color development recording operation shown in FIG. 4, high-level signals are output from the output terminals of the AND gates AG2 and AG3, so that only the electric resistance elements R2 and R3 are supplied with electric current, to be heated. In the multi-color development shown in FIG. 8, after the second latch signal LAT is output, one line's worth of the first two-color development bit data BD ((I) of FIG. 3) is written in the shift register 20.

After a sufficient time has passed, i.e., after the heating period for cyan has passed, the third latch signal LAT is output from the printer controller 12 to the latch circuit 22, and at this time, one line's worth of the first two-color development bit data BD is shifted from the shift register 20 to the latch circuit 22. Therefore, high-level signals are output from the output terminals of the AND gates AG1 and AG3, so that only the electric resistance elements R1 and R3 are supplied with electric current, to be heated.

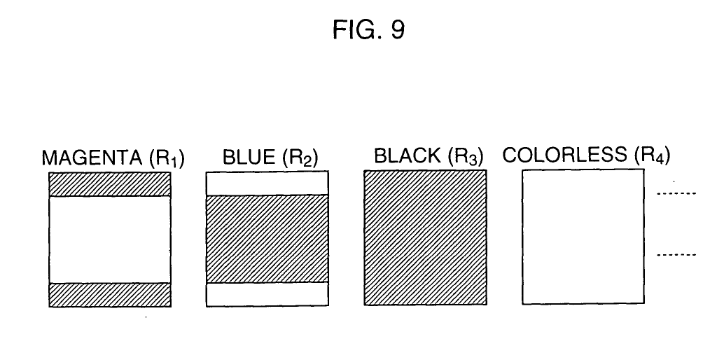

As a result, a magenta dot, a blue (i.e., magenta+cyan) dot, a black dot, and a colorless dot are formed on a color development layer of the multi-color development thermo-sensitive recording medium by the electric resistance elements R1, R2, R3, and R4, as schematically shown in FIG. 9. A remarkable point in the embodiment is that the magenta dot is formed in two magenta development areas contained in the full size area. Due to this, the following improvements are realized. The density of the magenta dot is lowered, and black is thickened since the electric resistance element R1 is heated twice.

The two current supply periods for the electric resistance element R1 are set in such a manner that during each period the heat temperature becomes higher than or equal to the magenta development temperature T1 and lower than the cyan development temperature T2. The current supply period for the electric resistance element R2 is set in such a manner that during this period the heat temperature becomes higher than or equal to the cyan development temperature T2 and lower than the black development temperature T3. The current supply period for the electric resistance element R3 is set in such a manner that during this period the heat temperature becomes higher than the black development temperature T3.

In the embodiments described above, the multi-color development thermal printer, the multi-color development method, and the multi-color development system use a multi-color development thermo-sensitive recording medium, in which magenta, cyan, and black are developed at low, intermediate, and high temperatures. However, the present invention can be applied to a multi-color development thermo-sensitive recording medium which can develop at least three colors at different temperatures.

Further, although the three-color pixel data process routine is executed in the host computer 14, the process routine may be executed in the printer controller 12, if necessary.

Further, the multi-color development thermal printer, the multi-color development method, and the multi-color development system can be applied to the pressure-sensitive/thermo-sensitive color development recording medium, which is disclosed in Japanese Unexamined Patent Publication Nos. 2002-19298A and 2002-293035A. A color development layer of the recording medium is composed of thermo-sensitive color development material and pressure-sensitive micro-capsule color development material, and the color development characteristics are related to pressure of the platen of the thermal head. If the pressure is set to a predetermined value, the present invention can be applied to the color development control of the recording medium.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2002-234591 (filed on Aug. 12, 2002) which is expressly incorporated herein, by reference, in its entirety.

1. A multi-color development thermal printer that develops simultaneously first, second, and third colors using a line-type thermal head, in accordance with one line's worth of three-color development pixel data, on a recording medium, which has color-characteristics such that a first color is developed at a first temperature, a second color is developed at a second temperature higher than said first temperature, and a third color is developed at a third temperature higher than said second temperature, said multi-color development thermal printer comprising:
a storing processor that stores one line's worth of first two-color development bit data generated based on one line's worth of said three-color development pixel data so as to develop said first and third colors, and one line's worth of second two-color development bit data generated based on one line's worth of said three-color development pixel data so as to develop said second and third colors; and
a recording processor that controls said line-type thermal head to perform a first recording operation based on one line's worth of said first two-color development bit data, and then controls said line-type thermal head to perform a second recording operation based on one line's worth of said second two-color development bit data, during a period required for carrying out a recording operation for every one line of said line-type thermal head.

2. A multi-color development thermal printer according to claim 1, wherein said recording processor controls said line-type thermal head to perform a third recording operation based on one line's worth of said first two-color development bit data, after performing said second recording operation based on one line's worth of said second two-color development bit data.

3. A multi-color development method that develops simultaneously first, second, and third colors using a line-type thermal head, in accordance with one line's worth of three-color development pixel data, on a recording medium, which has color-characteristics such that a first color is developed at a first temperature, a second color is developed at a second temperature higher than said first temperature, and a third color is developed at a third temperature higher than said second temperature, said multi-color development method comprising:
a first bit data generating step for generating one line's worth of first two-color development bit data based on one line's worth of said three-color development pixel data so as to develop said first and third colors;
a second bit data generating step for generating one line's worth of second two-color development bit data based on one line's worth of said three-color development pixel data so as to develop said second and third colors; and
a recording step for controlling said line-type thermal head to perform a first recording operation based on one line's worth of said first two-color development bit data, and for controlling said line-type thermal head to perform a second recording operation based on one line's worth of said second two-color development bit data, during a period required for carrying out a recording operation for every one line of said line-type thermal head.

4. A multi-color development method according to claim 3, wherein a first recording time of said line-type thermal head for performing said first recording operation is a time required for obtaining a first coloring temperature at which said first color occurs, and a second recording time of said line-type thermal head for performing said second recording operation is a time required for obtaining a second coloring temperature at which said second color occurs.

5. A multi-color development method according to claim 3, wherein, in said recording step, said line-type thermal head is controlled to perform a third recording operation based on one line's worth of said first two-color development bit data, after performing said second recording operation based on one line's worth of said second two-color development bit data.

6. A multi-color development method according to claim 5, wherein a first recording time of said line-type thermal head for performing said first recording operation is a time required for obtaining a first coloring temperature at which said first color occurs, a second recording time of said line-type thermal head for performing said second recording operation is a time required for obtaining a second coloring temperature at which said second color occurs, and a third recording time of said line-type thermal head for performing said third recording operation is a time required for obtaining a third coloring temperature at which said first color occurs.

7. A multi-color development system that develops simultaneously first, second, and third colors using a line-type thermal head, in accordance with one line's worth of three-color development pixel data, on a recording medium, which has color-characteristics such that a first color is developed at a first temperature, a second color is developed at a second temperature higher than said first temperature, and a third color is developed at a third temperature higher than said second temperature, said multi-color development system comprising:
a first bit data generator that generates one line's worth of first two-color development bit data based on one line's worth of said three-color development pixel data so as to develop said first and third colors;
a second bit data generator that generates one line's worth of second two-color development bit data based on one line's worth of said three-color development pixel data so as to develop said second and third colors;
a storing processor that stores one line's worth of each of said first and second two-color development pixel data; and
a recording processor that controls said line-type thermal head to perform a first recording operation based on one line's worth of said first two-color development bit data, and then controls said line-type thermal head to perform a second recording operation based on one line's worth of said second two-color development bit data, during a period required for carrying out a recording operation for every one line of said line-type thermal head.

8. A multi-color development system according to claim 7, wherein said recording processor controls said line-type thermal head to perform a third recording operation based on one line's worth of said first two-color development bit data, after performing said second recording operation based on one line's worth of said second two-color development bit data.

9. A multi-color development thermal printer that develops simultaneously first, second, and third colors using a line-type thermal head, in accordance with one line's worth of three-color development pixel data, on a recording medium, which has color-characteristics such that a first color is developed at a first temperature, a second color is developed at a second temperature higher than said first temperature, and a third color is developed at a third temperature higher than said second temperature, said multi-color development thermal printer comprising:
a storing processor that stores one line's worth of first two-color development bit data generated based on one line's worth of said three-color development pixel data so as to develop said first and third colors, and one line's worth of second two-color development bit data generated based on one line's worth of said three-color development pixel data so as to develop said second and third colors; and
a recording processor that controls said line-type thermal head to perform a second recording operation based on one line's worth of said second two-color development bit data, and then controls said line-type thermal head to perform a first recording operation based on one line's worth of said first two-color development bit data, during a period required for carrying out a recording operation for every one line of said line-type thermal head.

10. A multi-color development system that develops simultaneously first, second, and third colors using a line-type thermal head, in accordance with one line's worth of three-color development pixel data, on a recording medium, which has color-characteristics such that a first color is developed at a first temperature, a second color is developed at a second temperature higher than said first temperature, and a third color is developed at a third temperature higher than said second temperature, said multi-color development system comprising:
a first bit data generator that generates one line's worth of first two-color development bit data based on one line's worth of said three-color development pixel data so as to develop said first and third colors;
a second bit data generator that generates one line's worth of second two-color development bit data based on one line's worth of said three-color development pixel data so as to develop said second and third colors;
a storing processor that stores one line's worth of each of said first and second two-color development pixel data; and
a recording processor that controls said line-type thermal head to perform a second recording operation based on one line's worth of said second two-color development bit data, and then controls said line-type thermal head to perform a first recording operation based on one line's worth of said first two-color development bit data, during a period required for carrying out a recording operation for every one line of said line-type thermal head.
